(19) United States
(12) Patent Application Publication
(10) Pub. No.: US 2010/0178528 A1
(43) Pub. Date: Jul. 15, 2010

(54) TUNNEL MAGNETORESISTIVE THIN FILM AND MAGNETIC MULTILAYER FILM FORMATION APPARATUS

(75) Inventors: Koji Tsunekawa, Kawasaki-shi (JP); Yoshinori Nagamine, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON ANELVA CORPORATION, Kawasaki-shi, JP (JP)

(21) Appl. No.: 12/602,831

(22) PCT Filed: Jun. 6, 2008
(86) PCT No.: PCT/JP2008/060418

§ 371 Date: Feb. 25, 2010

(30) Foreign Application Priority Data
Jun. 19, 2007 (JP) 2007-161325

(51) Int. Cl. G11B 5/39

(52) U.S. Cl. 428/811.1; 428/811.2

(57) ABSTRACT

A tunnel magnetoresistive thin film which can simultaneously realize a high MR ratio and low magnetostriction is provided.

The tunnel magnetoresistive thin film comprises a magnetization fixed layer, a tunnel barrier layer, and a magnetization free layer, wherein the tunnel barrier layer is a magnesium oxide film containing magnesium oxide crystal grains and the magnetization free layer is a layered structure including a first magnetization free layer and a second magnetization free layer, the first magnetization free layer being made of alloy containing Co atoms, Fe atoms, and B atoms or containing Co atoms, Ni atoms, Fe atoms, and B atoms, having a body-centered cubic structure, and having (001) orientation, the second magnetization free layer being made of alloy containing Fe atoms and Ni atoms and having a face-centered cubic structure.

### TECHNICAL FIELD

The present invention relates to a tunnel magnetoresistive thin film used in a magnetic reproducing head of a magnetic disk drive, a storage element of a magnetic random access memory or in a magnetic sensor, and a magnetic multilayer film formation apparatus.

### BACKGROUND ART

A tunnel magnetoresistive thin film using amorphous CoFeB as a ferromagnetic electrode and MgO of a NaCl structure as a tunnel barrier layer exhibits quite a high MR ratio (magnetoresistance change ratio) equal to or higher than 200% at room temperature. Due to this, the tunnel magnetoresistive thin film is expected to be applied to a magnetic reproducing head of a magnetic disk drive, a storage element of a magnetic random access memory (MRAM) or a magnetic sensor. In the conventional tunnel magnetoresistive thin film using amorphous CoFeB as the ferromagnetic electrode and MgO of the NaCl structure as the tunnel barrier layer, a magnetization free layer is a COFeB monolayer having a large positive magnetostriction, which causes noise when a device operates.

Meanwhile, a current-generation magnetoresistive thin film using a huge magnetoresistance effect employs CoFe alloy as a first magnetization free layer so as to obtain a high MR ratio. However, the CoFe alloy layer has a high positive magnetostriction similarly to the CoFeB monolayer. Due to this, NiFe having a negative magnetostriction is layered as a second magnetization free layer, thereby reducing the magnetostriction of the entire magnetization free layers to practicable degree.

In the conventional tunnel magnetoresistive thin film using amorphous CoFeB as the ferromagnetic electrode and MgO of the NaCl structure as the tunnel barrier layer, if NiFe is layered on the CoFeB magnetization free layer so as to expect a similar effect to that stated above, the problem occurs that the MR ratio extremely falls. The reason is considered to be the fact that crystallization starts at the side of the NiFe layer when the amorphous CoFeB is crystallized in a high-temperature annealing treatment in a later step.

To solve such a problem, Patent Literature 1, for example, discloses a technique for adding Ni to a CoFeB magnetization free layer and reducing magnetostriction while the magnetization free layer remains a monolayer. Further, Patent Literature 2 discloses a configuration in which a nonmagnetic diffusion prevention layer is inserted between a first magnetization free layer and a second magnetization free layer.

Patent Literature 1: Japanese Patent Application Laid-Open No. 2007-95750

Patent Literature 2: Japanese Patent Application Laid-Open No. 2006-319259

### DISCLOSURE OF THE INVENTION

### Problems to be Solved by the Invention

It is an object of the present invention to provide a tunnel magnetoresistive thin film having both a high MR ratio and a low magnetostriction and a magnetic multilayer film formation apparatus.

### Means for Solving the Problems

A first tunnel magnetoresistive thin film according to the present invention is a tunnel magnetoresistive thin film comprising:

a magnetization fixed layer;

a tunnel barrier layer; and

a magnetization free layer,

wherein the tunnel barrier layer is a magnesium oxide film containing magnesium oxide crystal grains in (001) orientation, and

the magnetization free layer is a layered structure including a first magnetization free layer and a second magnetization free layer, the first magnetization free layer being made of alloy containing Co atoms, Fe atoms, and B atoms or containing Co atoms, Ni atoms, Fe atoms, and B atoms, having a body-centered cubic structure, and having (001) orientation, the second magnetization free layer being made of alloy containing Fe atoms and Ni atoms and having a face-centered cubic structure.

In a preferred embodiment of the present invention, the first magnetization free layer has a composition expressed as (Co_{100-x-y}NiₓFe_{y})_{100-z}B_{z}, where x, y, and z in atomic %, the composition satisfying x+y<100, 0≦x≦30, 10≦y<100, and 0<z≦6.

In a preferred embodiment of the present invention, a coercive force H_{cp} of the magnetization fixed layer and a coercive force H_{cf} of the magnetization free layer satisfy a relation of H_{cp}>H_{cf}.

In a preferred embodiment of the present invention, the tunnel magnetoresistive thin film further comprises an antiferromagnetic layer adjacent to the magnetization fixed layer,

wherein magnetization of the magnetization fixed layer is fixed in a uniaxial direction by exchange-coupling between the magnetization fixed layer and the antiferromagnetic layer, and

an exchange-coupled magnetic field Hₑₓ between the magnetization fixed layer and the antiferromagnetic layer and a coercive force H_{cf} of the magnetization free layer satisfy a relation of Hₑₓ<H_{cf}.

In a preferred embodiment of the present invention, the magnetization fixed layer includes a first magnetization fixed layer and a second magnetization fixed layer, and further includes an exchange-coupling nonmagnetic layer between the first magnetization fixed layer and the second magnetization fixed layer,

magnetization of the magnetization fixed layer is fixed in a uniaxial direction by exchange-coupling between the magnetization fixed layer and the antiferromagnetic layer,

the first magnetization fixed layer and the second magnetization fixed layer constitute an antiferromagnetically-coupled layered ferrimagnetic fixed layer, and

an antiferromagnetically-coupled magnetic field Hₑₓ* between the first magnetization fixed layer and the second magnetization fixed layer and a coercive force H_{cf} of the magnetization free layer satisfy a relation of Hₑₓ*>H_{cf}.

A second tunnel magnetoresistive thin film according to the present invention is a tunnel magnetoresistive thin film comprising:

a magnetization free layer;

a tunnel barrier layer; and

a magnetization fixed layer,

wherein the tunnel barrier layer is a magnesium oxide film containing magnesium crystal grains in (001) orientation, and

the magnetization free layer is an alloy layer having a body-centered cubic structure, having (001) orientation, and containing Co atoms, Fe atoms, and B atoms or containing Co atoms, Ni atoms, Fe atoms, and B atoms.

In a preferred embodiment of the present invention, the magnetization free layer has a composition expressed as (Co_{100-x-y}NiₓFe_{y})_{100-z}B_{z}, where x, y, and z in atomic %, the composition satisfying x+y<100, 0≦x≦30, 10≦y<100, and 0<z≦6.

A third tunnel magnetoresistive thin film according to the present invention is a tunnel magnetoresistive thin film comprising a layered body having a magnetization fixed layer, a tunnel barrier layer, a magnetization free layer layered in this order,

wherein the tunnel barrier layer is a magnesium oxide film containing magnesium crystal grains in (001) orientation, and

the magnetization free layer is a layered structure including a first magnetization free layer and a second magnetization free layer, the first magnetization free layer being made of alloy containing Co atoms, Fe atoms, and B atoms or containing Co atoms, Ni atoms, Fe atoms, and B atoms, having a body-centered cubic structure, and having (001) orientation, the second magnetization free layer being made of alloy containing Fe atoms and Ni atoms and having a face-centered cubic structure.

A first magnetic multilayer film formation apparatus according to the present invention is a magnetic multilayer film formation apparatus comprising:

a transport chamber including a substrate transport device;

a first film formation chamber, arranged to be connected to the transport chamber via a gate valve, for forming a magnesium oxide layer containing magnesium oxide crystal grains in (001) orientation by a sputtering method using a magnesium oxide target;

a second film formation chamber, arranged to be connected to the transport chamber via a gate valve, for forming a crystalline first magnetization free layer made of alloy containing Co atoms, Fe atoms, and B atoms or alloy containing Co atoms, Ni atoms, Fe atoms, and B atoms, having a body-centered cubic structure, and having (001) orientation by the sputtering method using a magnetic target containing Co atoms, Fe atoms, and B atoms or a magnetic target containing Co atoms, Ni atoms, Fe atoms, and B atoms, and for forming a second magnetization free layer made of FeNi alloy containing Fe atoms and Ni atoms and having a face-centered cubic structure by the sputtering method using a magnetic target containing Fe atoms and Ni atoms; and

a vacuum transport mechanism for layering the first magnetization free layer on a substrate so as to be adjacent to the magnesium oxide layer, and for layering the second magnetization free layer so as to be adjacent to the first magnetization free layer.

A second magnetic multilayer film formation apparatus according to the present invention is a magnetic multilayer film formation apparatus comprising:

a transport chamber including a substrate transport device;

a first film formation chamber, arranged to be connected to the transport chamber via a gate valve, for forming a magnesium oxide layer containing magnesium oxide crystal grains in (001) orientation by a sputtering method using a magnesium oxide target;

a second film formation chamber, arranged to be connected to the transport chamber via a gate valve, for forming a crystalline first magnetization free layer made of alloy containing Co atoms, Fe atoms, and B atoms or alloy containing Co atoms, Ni atoms, Fe atoms, and B atoms, having a body-centered cubic structure, and having (001) orientation by a double simultaneous sputtering method using a first magnetic target containing at least two components selected from among Co atoms, Ni atoms, Fe atoms, and B atoms and a second magnetic target containing at least components selected from among the four components and unused in the first magnetic target, and for forming a second magnetization free layer made of FeNi alloy containing Fe atoms and Ni atoms and having a face-centered cubic structure by the sputtering method using a magnetic target containing Fe atoms and Ni atoms; and

a vacuum transport mechanism for layering the first magnetization free layer on a substrate so as to be adjacent to the magnesium oxide layer, and for layering the second magnetization free layer so as to be adjacent to the first magnetization free layer.

A third magnetic multilayer film formation apparatus according to the present invention is a magnetic multilayer film formation apparatus comprising:

a transport chamber including a substrate transport device;

a first film formation chamber, arranged to be connected to the transport chamber via a gate valve, for forming a metal magnesium layer by a sputtering method using a magnesium target;

an oxidation treatment chamber, arranged to be connected to the transport chamber via a gate valve, for transforming the magnesium layer into a magnesium oxide layer containing magnesium oxide crystal grains in (001) orientation;

a second film formation chamber, arranged to be connected to the transport chamber via a gate valve, for forming a crystalline first magnetization free layer made of alloy containing Co atoms, Fe atoms, and B atoms or alloy containing Co atoms, Ni atoms, Fe atoms, and B atoms, having a body-centered cubic structure, and having (001) orientation by a double simultaneous sputtering method using a first magnetic target containing at least two components selected from among Co atoms, Ni atoms, Fe atoms, and B atoms and a second magnetic target containing at least components selected from among the four components and unused in the first magnetic target, and for forming a second magnetization free layer made of FeNi alloy containing Fe atoms and Ni atoms and having a face-centered cubic structure by the sputtering method using a magnetic target containing Fe atoms and Ni atoms; and

a vacuum transport mechanism for layering the first magnetization free layer on a substrate so as to be adjacent to the magnesium oxide layer, and for layering the second magnetization free layer so as to be adjacent to the first magnetization free layer.

A fourth magnetic multilayer film formation apparatus according to the present invention is a magnetic multilayer film formation apparatus comprising:

a transport chamber including a substrate transport device;

a first film formation chamber, arranged to be connected to the transport chamber via a gate valve, for forming a metal magnesium layer by a sputtering method using a magnesium target;

an oxidation treatment chamber, arranged to be connected to the transport chamber via a gate valve, for transforming the magnesium layer into a magnesium oxide layer containing magnesium oxide crystal grains in (001) orientation;

a second film formation chamber, arranged to be connected to the transport chamber via a gate valve, for forming a crystalline first magnetization free layer made of alloy containing Co atoms, Fe atoms, and B atoms or alloy containing Co atoms, Ni atoms, Fe atoms, and B atoms, having a body-centered cubic structure, and having (001) orientation by the sputtering method using a magnetic target containing Co atoms, Fe atoms, and B atoms or a magnetic target containing Co atoms, Ni atoms, Fe atoms, and B atoms, and for forming a second magnetization free layer made of FeNi alloy containing Fe atoms and Ni atoms and having a face-centered cubic structure by the sputtering method using a magnetic target containing Fe atoms and Ni atoms; and

a vacuum transport mechanism for layering the first magnetization free layer on a substrate so as to be adjacent to the magnesium oxide layer, and for layering the second magnetization free layer so as to be adjacent to the first magnetization free layer.

According to the present invention, in “body-centered cubic structure” and “face-centered cubic structure” described as definition of “crystal orientation” in the specification of the present application (“present specification”), the following six crystal faces are equivalent.

Crystal Faces

(100),(010),(001),( 1̅00),(0 1̅0),(001) [Chemical Formula 1]

In the present specification, a perpendicular direction to a film surface is defined as a c-axis of a crystallographic axis and the sixth crystal face orientations are all expressed as “(001) orientation”.

Furthermore, the evidence that the MgO tunnel barrier layer has (001) orientation is as follows. According to an X-ray diffraction (θ−2θ) method, if a (200) diffraction peak appears only near 2θ=43°, it is understood indirectly that the MgO tunnel barrier layer has the (001) orientation. Further, as a more direct check method, a cross-sectional image is observed by a transmission electron microscope (TEM) and it can be confirmed that the MgO tunnel barrier layer has the (001) orientation from a grating space. At that time, if an electron beam is irradiated on the MgO layer to analyze a diffraction pattern of the MgO layer, it can be confirmed more clearly that the MgO tunnel barrier layer has the (001) orientation.

Likewise, it is possible to confirm indirectly by X-ray diffraction using a CuK α-ray that the first magnetization free layer of the “body-centered cubic structure” has (001) orientation. In case of the (001) orientation, a diffraction peak appears only near 2θ=65.5°.

If the second magnetization free layer has the “body-centered cubic structure” mainly containing Ni and Fe, the orientation of the second magnetization free layer can be indirectly confirmed by X-ray diffraction using the CuK α-ray, and diffraction peaks appear near 2θ=44.5°, 51.9°, 76.5° and 93.1°, respectively. Depending on crystal orientation, all the peaks appear simultaneously on one occasion and only one peak appears on another occasion. To confirm that the second magnetization free layer has the “body-centered cubic structure” more clearly, an electron beam is irradiated on a sample cross-section by the TEM to analyze a diffraction pattern, for example.

### EFFECTS OF THE INVENTION

In the tunnel magnetoresistive thin film according to the present invention, the MR ratio does not fall even if the NiFe alloy having the negative magnetostriction is layered on the CoFiFeB magnetization free layer to reduce the magnetostriction despite use of the CoFiFeB magnetization free layer having the positive magnetostriction so as to obtain the high MR ratio. Accordingly, it is possible to provide the tunnel magnetoresistive thin film having both the high MR ratio and the low magnetostriction, and to ensure good characteristics by applying the tunnel magnetoresistive thin film to a magnetic reproducing head of a magnetic disk drive, a storage element of an MRAM or to a magnetic sensor.

Furthermore, the tunnel magnetoresistive thin film according to the present invention can exhibit considerably improved stability of MR ratio against heat.

The apparatus according to the present invention can produce tunnel magnetoresistive thin films excellent in stability of a high MR ratio against heat while ensuring high productivity.

### BRIEF DESCRIPTION OF THE DRAWINGS

FIG. 1 is a cross-sectional pattern view of a tunnel magnetoresistive thin film according to an embodiment of the present invention.

FIG. 2 is a plan view typically showing a configuration of a sputtering device for manufacturing the tunnel magnetoresistive thin film according to the present invention.

FIG. 3 shows a configuration of an MRAM.

FIG. 4 is a cross-sectional pattern view of one memory cell in the MRAM shown in FIG. 3.

FIG. 5 is an equivalent circuit diagram of one memory cell in the MRAM shown in FIG. 3.

FIG. 6 shows dependence of an MR ratio of the tunnel magnetoresistive thin film to an annealing temperature according to Example 1 of the present invention and that according to a comparison.

### EXPLANATION OF REFERENCE NUMERALS

1 Substrate
2 Buffer layer
3 Antiferromagnetic layer
4 Magnetization fixed layer
4a First magnetization fixed layer
4b Second magnetization fixed layer
5 Exchange-coupling nonmagnetic layer
6 Tunnel barrier layer
7 Magnetization free layer
7a First magnetization free layer
7b Second magnetization free layer
7c Third magnetization free layer
8 Protection layer
9 Exchange-coupling nonmagnetic layer
20 Vacuum transport chamber
21, 22, 23 Sputtering chamber
21a Ta target
21b PtMn target
21c Co₇₀Fe₃₀ target
21d Ru target
21e Co₆₀Fe₂₀B₂₀ target
22a MgO target
22b Mg target
22c Unattached target
22d Unattached target
22e Unattached target
23a Ta target
23b Co₇₀Fe₃₀ target
23c Ru target
23d Co₅₆Fe₂₄B₂₀ target
23e Ne₈₃Fe₁₇ target
25 Substrate pretreatment chamber
26 Oxidation treatment chamber
27 Load lock chamber
28 Transport robot
42 Rewrite word line
43 Bit line
44 Read word line
45 TMR element
46 Transistor

### BEST MODE FOR CARRYING OUT THE INVENTION

Embodiments of the present invention will be described hereinafter with reference to the drawings.

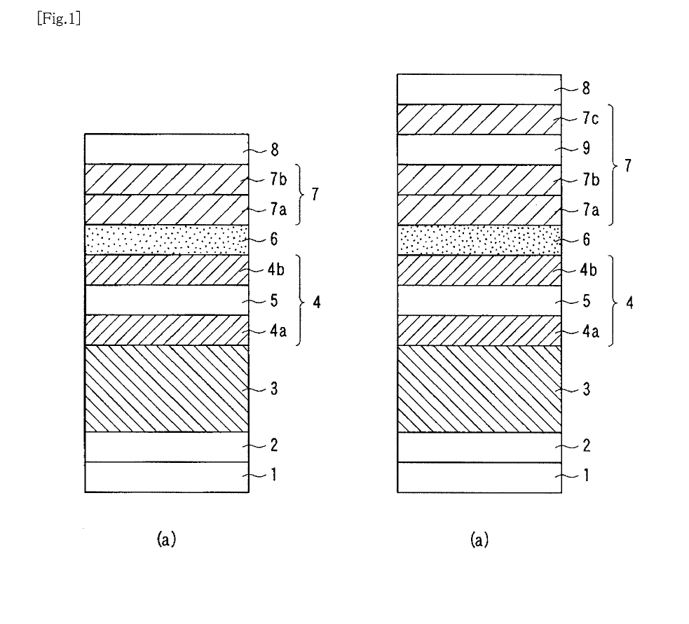

FIG. 1(a) is a cross-sectional pattern diagram of a tunnel magnetoresistive thin film according to a preferred embodiment of the present invention.

The tunnel magnetoresistive thin film according to the present invention includes a layered product in which a tunnel barrier layer is put between a magnetization fixed layer and a magnetization free layer. According to the present invention, it is preferable to arrange an antiferromagnetic layer adjacent to the magnetization fixed layer in the layered product, thereby providing a spin-valve tunnel magnetoresistive thin film in which magnetization of the magnetization fixed layer is fixed in a uniaxial direction by exchange-coupling between the magnetization fixed layer and the antiferromagnetic layer. FIG. 1(a) shows an example of a configuration of a bottomed spin-valve tunnel magnetoresistive thin film including this antiferromagnetic layer and layering the antiferromagnetic layer with a buffer layer arranged on substrate side.

In FIG. 1(a), reference numeral 1 denotes a substrate, 2 denotes the buffer layer, 3 denotes the antiferromagnetic layer, 4 denotes the magnetization fixed layer, 5 denotes an exchange-coupling nonmagnetic layer, 6 denotes the tunnel barrier layer, 7 denotes the magnetization free layer, and 8 denotes a protection layer.

The present invention is constitutionally characterized in that the first magnetization free layer 7a adjacent to the tunnel barrier layer 6 is made of CoNiFeB alloy, composition of which preferably falls within a specific range. That is, the composition expressed as (Co_{100-x-y}NiₓFe_{y})_{100-z}B_{z} (where x, y, and z in atomic %) falls within the range satisfying x+y<100, 0≦x≦30, 10≦y<100, and 0<z≦6. The range of the composition of the first magnetization free layer 7a adjacent to the tunnel barrier layer 6 includes x=0, that is, the first magnetization free layer 7a may have the composition of CoFeB without Ni. However, the composition will be expressed as CoNiFeB including the instance of x=0 only if the first magnetization free layer 7a is adjacent to the tunnel barrier layer 6.

According to the present invention, it is possible to contain another metal such as Al, Zr, Ti, Hf or P, and C, Si or the like in the CoNiFeB alloy as traces of (1 atomic % or lower, preferably 0.05 atomic % or lower) addition ingredients.

A magnesium oxide layer according to the present invention can contain metal such as Ti, Al, Zr, Ru, Ta or P, and C, Si or the like as traces of (1 atomic % or lower, preferably 0.05 atomic % or lower) addition ingredients.

Moreover, if the CoNiFeB film is layered on the MgO layer containing MgO crystal grains having an (001) orientation, the CoNiFeB film has a body-centered cubic structure in the (001) orientation and the magnetoresistive thin film having such a configuration exhibits advantages of the present invention. Therefore, as described below, the present invention uses a configuration in which the MgO film containing MgO crystal grains in the (001) orientation is used as the tunnel barrier layer 6, and in which the CoNiFeB film is layered on the MgO film as a first magnetization free layer 7a.

In the present invention, a configuration including layered films equal to or two layers different in magnetic material from one another is preferably applied as a configuration of the magnetization free layer 7, as shown in FIG. 1. FIG. 1(a) shows an example in which the magnetization free layer 7 is configured to include two layers 7a and 7b. FIG. 1(b) shows an example in which the magnetization free layer 7 is configured to include three layers 7a, 7b, and 7c. In FIG. 1(b), reference numeral 9 denotes an exchange-coupling nonmagnetic layer. If the magnetization free layer 7 is configured to include a plurality of layers as stated above, the first magnetization free layer 7a adjacent to the tunnel barrier layer 6 is made of CoNiFeB having the above-stated specific composition. Moreover, it is preferable that at least one of the magnetization free layers 7b and 7c other than the first magnetization free layer 7a is made of NiFe alloy (NiFe) containing 50 atomic % or more of Ni and having the face-centered cubic structure. An Ni content of the NiFe is preferably set to be equal to or higher than 82 atomic % so as to have a negative magnetostriction. In the configuration shown in FIG. 1(b), the second magnetization free layer 7b may be made of NiFe containing 50 atomic % or more of Ni and having the face-centered cubic structure, and the third magnetization free layer 7c may be made of CoFe alloy (CoFe) or CoNiFe alloy (CoNiFe). As a material of the exchange-coupling nonmagnetic layer 9, Ru is preferably used.

Thicknesses of the first magnetization free layer 7a and the second magnetization free layer 7b shown in FIG. 1(a) are set, respectively so as to be able to have a higher MR ratio and to make the magnetostriction closer to zero. Preferably, the thickness of the first magnetization free layer 7a is 1 nm to 3 nm and that of the second magnetization free layer 7b is 1 nm to 5 nm.

In the present invention, definition that “layers different in magnetic material from one another” includes an instance in which “magnetic materials different in constituent elements”, an instance in which “magnetic materials different in combination of constituent elements”, and an instance in which “magnetic materials equal in combination of constituent elements but different in composition rate”.

In the present invention, the above-stated alloys such as CoNiFe, NiFe and CoFe include not only those in which only one of these elements is 100 atomic % but also those containing traces of other elements in a range of not affecting the advantages of the present invention. For example, one alloy that contains traces of other elements than Ni and Fe is assumed to be defined as NiFe if the alloy is equal to an alloy the content of which is 100 atomic % only by Ni and Fe in level in terms of the advantages of the present invention.

In the present invention, the MgO film containing MgO crystal grains in the (001) orientation is used as the tunnel barrier layer 6. Orientation of the MgO film can be confirmed by X-ray diffraction. That is, using X-ray diffraction (θ−2θ method), it can be indirectly confirmed that the MgO film has the (001) orientation if a (200) diffraction peak appears around 2θ=43°. Further, as a more direct check method, a cross-sectional image is observed by a TEM and it can be confirmed that the MgO layer has the (001) orientation from its grating space. At that time, if an electron beam is irradiated on the MgO layer to analyze a diffraction pattern of the MgO layer, it can be confirmed more clearly that the MgO layer has the (001) orientation.

As the tunnel barrier layer 6, a two-layered Mg/MgO film may be used. In relation to the Mg/MgO film, Tsunekawa et al. delivered a report in Appl. Phys. Lett., 87, 072503 (2005). A thickness of each of the MgO film and the two-layered Mg/MgO film changes according to a tunnel junction resistance (RA) of the tunnel magnetoresistive thin film. Since the RA necessary for the magnetic head or magnetic random access memory is 1 Ωμm² to 10,000 ΩΞm², the thickness is typically between 1 nm and 2 nm.

MgO used in the present invention may have either a stoichiometric proportion of 1:1 or non-stoichiometric proportion.

As shown in FIG. 1, the magnetization fixed layer 4 according to the present invention is preferably a layered ferrimagnetic fixed layer configured so that the exchange-coupling nonmagnetic layer 5 is sandwiched between a first magnetization fixed layer 4a and a second magnetization fixed layer 4b, and so that the first magnetization fixed layer 4a and the second magnetization fixed layer 4b are coupled antiferromagnetically. It is preferable to use CoFe for the first magnetization fixed layer 4a and CoFeB for the second magnetization fixed layer 4b. It is also preferable to use Ru for the exchange-coupling nonmagnetic layer 5 sandwiched between these magnetization fixed layers 4a and 4b. It is necessary to set a thickness of the Ru layer so that antiferromagnetic coupling appears between the CoFe layer and the CoFeB layer by RKKY (Ruderman Kittel Kasuya Yoshida) interaction. Practically, the thickness of the Ru layer is preferably in a range from 0.7 nm to 0.9 nm which range is referred to as “2nd peak”.

In case of a spin-valve tunnel magnetoresistive thin film in which the magnetization fixed layer 4 is not the layered ferrimagnetic fixed layer, equivalent effects can be obtained by using amorphous CoFeB for the magnetization fixed layer 4. A thickness of the amorphous CoFeB layer 4 is preferably from 1 nm to 5 nm.

In the present invention, it is preferable that a coercive force H_{cp} of the magnetization fixed layer 4 and a coercive force H_{cf} of the magnetization free layer 7 satisfy a relation of H_{cp}>H_{cf} if the antiferromagnetic layer 3 is not present. It is preferable that an exchange-coupled magnetic field Hₑₓ between the magnetization fixed layer 4 and the antiferromagnetic layer 3 satisfies a relation of Hₑₓ>H_{cf} if the antiferromagnetic layer 3 is present and the magnetization fixed layer 4 is not the layered ferrimagnetic fixed layer. It is preferable that an antiferromagnetically-coupled magnetic field Hₑₓ* between the first magnetization fixed layer 4a and the second magnetization fixed layer 4b if the antiferromagnetic layer 3 is present and the magnetization fixed layer 4 is the layered ferrimagnetic fixed layer.

The reason is that it is necessary to invert only magnetization of the magnetization free layer by applying an external magnetic field H so as to express a tunnel magnetoresistive effect, and to realize a state in which the magnetization fixed layer and the magnetization free layer are parallel or anti-parallel to each other in magnetization. A magnitude of the external magnetic field H realizing that state should satisfy H_{cp}>H>H_{cf}, Hₑₓ>H>H_{cf} or Hₑₓ*>H>H_{cf}. Due to this, it is preferable that H_{cp}, Hₑₓ or Hₑₓ* is as greater than H_{cf} as possible.

PtMn is preferably used for the antiferromagnetic layer 3 according to the present invention, and a thickness of the antiferromagnetic layer 3 is preferably 10 nm to 30 nm since the antiferromagnetic layer 3 needs the thickness so that strong antiferromagnetic coupling can appear. As a material of the antiferromagnetic layer 3, IrMn, IrMnCr, NiMn, PdPtMn, RuRhMn, OsMn or the like other than PtMn is preferably used.

According to the present invention, it is preferable that the magnetization free layer is a layered film of two or more layers having different magnetic materials, the first magnetization free layer adjacent to the tunnel barrier layer is made of the CoNiFeB alloy, and that at least one layer out of the magnetization free layers other than the first magnetization free layer is made of NiFe alloy containing 50 atomic % or more of Ni and having the face-centered cubic structure.

A method of manufacturing the tunnel magnetoresistive thin film according to the present invention will next be described. The tunnel magnetoresistive thin film according to the present invention may be manufactured by layering desired films from substrate 1-side in sequence.

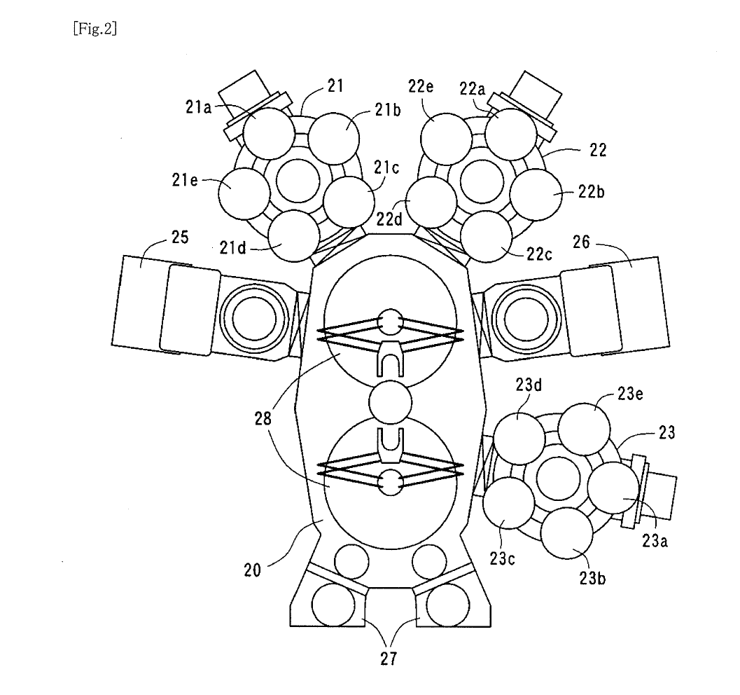

FIG. 2 is a plan view typically showing a configuration of a sputtering device for manufacturing the tunnel magnetoresistive thin film according to the present invention. The sputtering device is configured to include a vacuum transport chamber (transport chamber) 20 in which two substrate transport robots (substrate transport devices) 28 are mounted, sputtering chambers (film formation chambers) 21 to 23 connected to the vacuum transport chamber 20, a substrate pretreatment chamber 25, an oxidation treatment chamber 26, and a load lock chamber 27. All the chambers except for the load lock chamber 27 are vacuum chambers at a pressure equal to or lower than 2×10⁻⁶ Pa, and the vacuum transport robots 28 move the substrate among the respective vacuum chambers in vacuum. Reference numerals 21a to 21e, 22a to 22e, and 23a to 23e are targets.

A substrate for forming the spin-valve tunnel magnetoresistive thin film is arranged first in the load lock chamber 27 exposed to atmospheric pressure, the load lock chamber 27 is evacuated to vacuum, and the substrate is transported into a desired vacuum chamber by the vacuum transport robots 28.

By way of example, an instance of manufacturing a bottomed spin-valve tunnel magnetoresistive thin film produced in examples to be described later and including the layered ferrimagnetic fixed layer as the magnetization fixed layer will be described.

Constitutions of respective layers are as follows. The Ta (10 nm) buffer layer 2 is formed by sputtering film formation in the sputtering chamber 21 using the Ta target 21a. The PtMn (15 nm) antiferromagnetic layer 3 is layered on the Ta buffer layer 2 by sputtering film formation in the sputtering chamber 21 using the PtMn target 21b. The Co₇₀Fe₃₀ layer 4a of the magnetization fixed layer 4 is layered on the PtMn antiferromagnetic layer 3 by sputtering film formation in the sputtering chamber 21 using the Co₇₀Fe₃₀ target 21c. The Ru layer 5 of the magnetization fixed layer 4 is layered on the layer 4a by sputtering film formation in the sputtering chamber using the Ru target 21d. The CoFe layer 4b of the magnetization fixed layer 4 is layered on the Ru layer 5 by sputtering film formation in the sputtering chamber 21 using the Co₆₀Fe₂₀B₂₀ target 21e. The magnetization fixed layer 4 that is the layered ferrimagnetic fixed layer configured to include CoFe (2.5 nm)/Ru (0.85 nm)/CoFeB (3 nm) is thus formed.

The sputtering chamber 22 is a sputtering chamber using the MgO target 22a and the Mg target 22b. The targets 22c to 22e are unattached targets. The crystalline MgO (1.5 nm) tunnel barrier layer 6 in (001) orientation is layered on the magnetization fixed layer 4 by film formation in the sputtering chamber 22. In this embodiment, the tunnel barrier layer 6 having a layered structure of an Mg layer and an MgO layer is used. The crystalline MgO may have a monocrystalline structure over its entire thickness in a thickness direction, a monocrystalline structure in a face structure (monocrystal uniform over a device area) or a polycrystalline structure (a crystal state in which the MgO contains many crystal grains in the device area). Alternatively, a single-layer MgO tunnel barrier layer 6 can be used.

In a preferred embodiment of the present invention, the metal Mg layer is layered, a layered intermediate medium up to this Mg layer is transported into the oxidation treatment chamber 26, and the metal Mg layer is oxidized in this oxidation treatment chamber 26, whereby the crystalline MgO tunnel barrier layer 6 in the (001) orientation can be formed.

The sputtering chamber 23 uses the Ta target 23a, the Co₇₀Fe₃₀ target 23b, the Ru target 23c, the Co₅₆Fe₂₄B₂₀ target 23d, and the Ni₈₃Fe₁₇ target 23e.

The Ta target 23a is used to form the protection film 8. The magnetization free layer 7a having the body-centered cubic structure and made of CoFeNiB in the (001) orientation is layered by double simultaneous sputtering using the Co₅₆Fe₂₄B₂₀ target 23d and the Ni₈₃Fe₁₇ target 23e. Furthermore, the magnetization free layer 7b having the face-centered cubic structure and made of NiFe alloy is layered by sputtering using the Ni₈₃Fe₁₇ target 23e. The exchange-coupling nonmagnetic layer 9 made of Ru is layered by sputtering using the Ru target 23c, and the magnetization free layer 7c made of CoFe alloy is layered by sputtering using the Co₇₀Fe₃₀ target 23b.

Next, the protection layer 8 having a layered structure of a Ta layer (10 nm) and a Ru layer (7 nm) on magnetization free layer 7-side is layered on the magnetization free layer 7 by sputtering using the Ta target 23a and the Ru target 23b.

It is to be noted that a numeric value in each parenthesis indicates film thickness.

Composition of the sputtering target and film formation conditions (gas species, gas pressure, and applied power) of the PtMn layer are adjusted so that the PtMn layer is ordered, expresses antiferromagnetism and has a Pt content of 47 to 51 (atomic %).

To efficiently form the films structured as stated above, the sputtering targets are arranged in the respective sputtering chambers as follows. Ta, PtMn, Co₇₀Fe₃₀, Ru, and Co₆₀Fe₂₀B₂₀ are arranged in the sputtering chamber 21 as the sputtering targets 21a to 21e, respectively, and MgO and Mg are arranged in the sputtering chamber 22 as the sputtering targets 22a and 22b, respectively. Further, Ta, Co₇₀Fe₃₀, Ru, Co₅₆Fe₂₄B₂₀, and Ni₈₃Fe₁₇ are arranged in the sputtering chamber 23 as the sputtering targets 23a to 23e, respectively.

The spin-valve tunnel magnetoresistive thin film having the layered ferrimagnetic configuration that has the most complicated film configuration according to the present invention is formed as follows.

First, the substrate 1 is transported into the substrate pretreatment chamber 25. In the substrate pretreatment chamber 25, a surface layer of the substrate 1 which surface layer has a thickness of about 2 nm and is contaminated in the air is physically removed by inverse sputtering-etching. Thereafter, the resultant substrate 1 is transported into the sputtering chamber 21. In the sputtering chamber 21, constituent layers up to Ta/PtMn/CoFe/Ru/CoFeB films are formed. The resultant substrate 1 is moved into the sputtering chamber 22. In the sputtering chamber 22, the MgO film or two-layered film of Mg/MgO is formed as the tunnel barrier layer 6.

As a method of forming the MgO tunnel barrier layer 6, the metal Mg film may be formed in the sputtering chamber 22, the substrate 1 is then transported into the oxidation treatment chamber 26, where the Mg layer may be oxidized by a radical oxidation method, a natural oxidation method or the like to form the MgO film having an NaCl structure. After forming the tunnel barrier layer 6, the substrate 1 is transported into the sputtering chamber 23. In the sputtering chamber 23, CoFeB/NiFe/Ta/Ru films are formed and the resultant substrate 1 is fed to the load lock chamber 27. At this time, a double simultaneous sputtering method of simultaneously discharging the CoFeB and CoFe targets is adopted so as to form CoFeB layers having different B concentrations.

The tunnel magnetoresistive thin film thus produced is put in a magnetic-field annealing furnace. In the furnace, the tunnel magnetoresistive thin film is subjected to annealing in vacuum at a desired temperature for desired time while applying a magnetic field at an intensity equal to or higher than 8 kOe in parallel to one direction to the tunnel magnetoresistive thin film. Empirically, the temperature is preferably equal to or higher than 250° C. and equal to or lower than 360° C., and annealing time is preferably as long as five hours or longer at low temperature and as short as two hours or shorter at high temperature.

The tunnel magnetoresistive thin film according to the present invention is used preferably in a magnetic reproducing head of a magnetic disc drive, a storage element of a magnetic random access memory (MRAM) or in a magnetic sensor. The MRAM using the tunnel magnetoresistive thin film according to the present invention will be described by way of example.

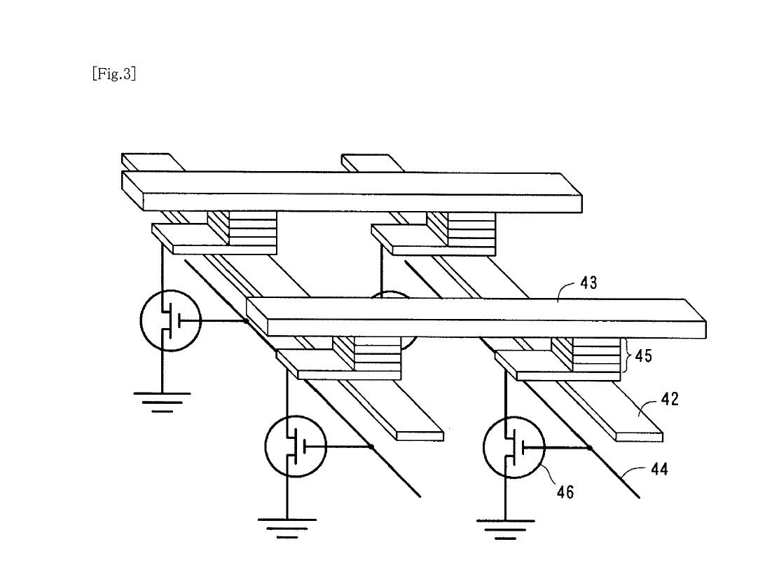

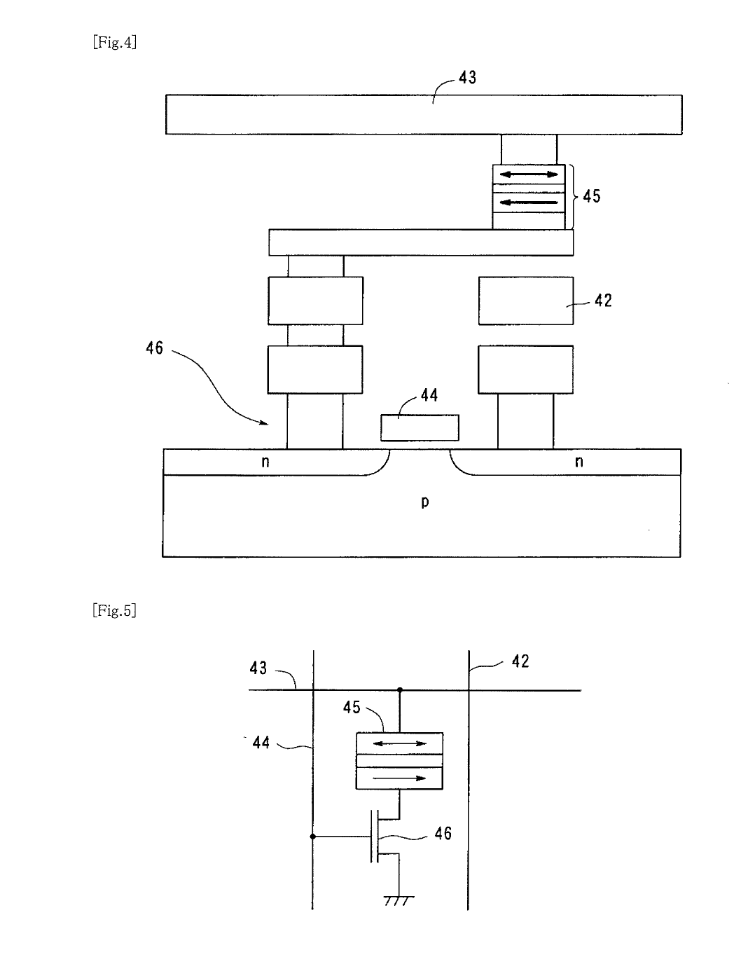

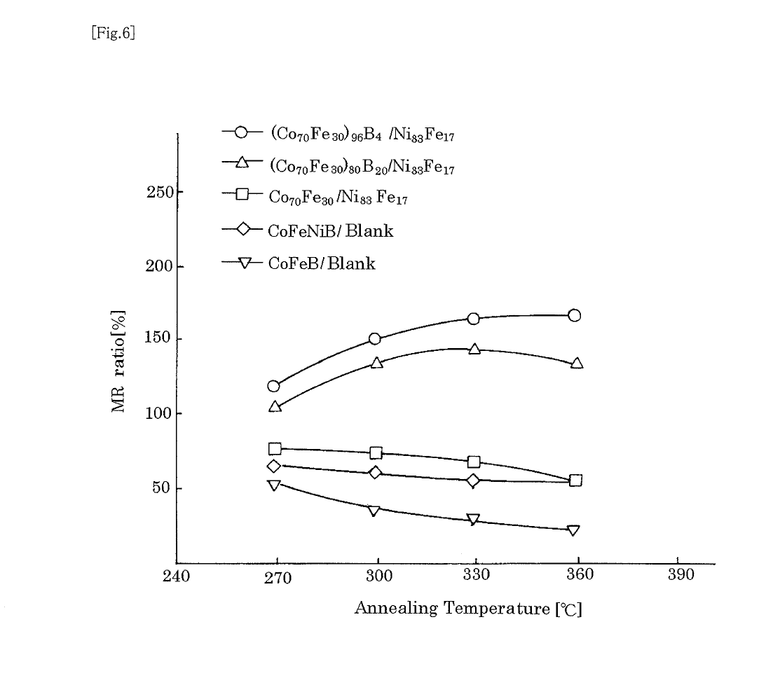

FIG. 3 shows a structure of the MRAM. FIG. 4 is a cross-sectional pattern view of one memory cell in the MRAM shown in FIG. 3. FIG. 5 is an equivalent circuit diagram of one memory cell. In the MRAM, reference numeral 42 denotes a rewrite word line, 43 denotes a bit line, 44 denotes a read word line, and 45 denotes a magnetoresistive element. Many memory cells are arranged at points of intersecting points between a plurality of bit lines 43 and a plurality of read word lines 44, respectively in lattice-like positional relationship. Each memory cell stores therein one-bit information.

As shown in FIGS. 4 and 5, each memory cell of the MRAM is configured to include the magnetoresistive (TMR) element 45 storing therein one-bit information and a transistor 46 having a switch function at the position of each of the intersecting points between the bit lines 43 and the read word lines 44. The tunnel magnetoresistive thin film according to the present invention is used as the TMR element 45.

An external magnetic field is applied to the TMR element 45 in a state in which constant current flows across the TMR element 45 by applying a required voltage to between the ferromagnetic layers (second magnetization fixed layer 4b and magnetization free layer 7) on both sides of the tunnel barrier layer 6 shown in FIG. 1(a), respectively. The TMR element 45 has minimum electric resistance when the second magnetization fixed layer 4b and the magnetization free layer 7 are parallel and identical in a direction of magnetization (in a parallel state), and has maximum electric resistance when the second magnetization fixed layer 4b and the magnetization free layer 7 are parallel and opposite in the direction of magnetization (in an anti-parallel state). In this way, the TMR element 45 can store therein information of “1” or “0” as a resistance change by creating the parallel state and anti-parallel state in the TMR element 45 by the external magnetic force.

In the MRAM shown in FIG. 3, one rewrite word line 42 is arranged below the TMR element 45 in parallel to one read word line 44, that is, to intersect one bit line 43. Therefore, a magnetic field is induced by carrying current to the bit line 43 and the rewrite word line 42, and magnetization of only the magnetization free layer of the TMR element 45 of the memory cell at the intersecting point between the bit line 43 and the rewrite word line 42 is inverted by influence of magnetic fields from both the bit line 43 and the rewrite word line 42. The TMR elements 45 of the other memory cells are either influenced at all by the magnetic fields from both the bit line 43 and the rewrite word line 42 or influenced only by the magnetic field from one of the bit line 43 and the rewrite word line 42. Due to this, magnetization of the magnetization free layer of each of the TMR elements 45 of the other memory cells is not inverted. In this way, write operation is performed by inverting the magnetization of only the magnetization free layer of the TMR element 45 of a desired memory cell. In read operation, a gate of the transistor 46 located below the TMR element 45 plays a role of the read word line 44. Current flows only through the TMR element 45 of the memory cell located at the intersecting point between the bit line 43 and the read word line 44. Therefore, it is possible to measure a resistance of the TMR element and obtain information of “1” or “0” by detecting voltage at the time the current flows.

### EXAMPLES

### Example 1

The bottomed spin-valve tunnel magnetoresistive thin film having the film configuration shown in FIG. 1(a) was produced using the device shown in FIG. 2. In Example 1, the buffer layer 2 was Ta (10 nm), the antiferromagnetic layer 3 was PtMn (15 nm), the magnetization fixed layer 4 was the layered ferrimagnetic fixed layer configured to include CoFe (2.5 nm)/Ru (0.85 nm)/CoFeB (3 nm), and the tunnel barrier layer 6 was MgO (15 nm). Furthermore, as the magnetization free layer 7, a CoNiFe film having the body-centered cubic structure in a state of being formed was formed first and a NiFe film having the face-centered cubic structure was then formed. As the protection layer 8, a layered structure of Ta (10 nm)/Ru (7 nm) was used.

Moreover, (Co₇₀Fe₃₀)₉₆B₄ was used as the first magnetization free layer 7a and Ni₈₃Fe₁₇ containing 83 atomic % of Ni and having the face-centered cubic structure was used as the second magnetization free layer 7b. Further, magnetoresistive thin films were manufactured while using (Co₇₀Fe₃₀)₈₀B₂₀ and Co₇₀Fe₃₀ for the first magnetization free layers 7a, respectively.

FIG. 6 shows dependences of MR ratios of tunnel magnetoresistive thin films manufactured in Example 1 on an annealing temperature, respectively. As the second magnetization free layer 7b, Ni₈₃Fe₁₇ having a negative magnetostriction was used in each of the tunnel magnetoresistive thin films so as to reduce the negative magnetostriction.

FIG. 6 shows dependences of the MR ratios of test samples on annealing by measuring the MR ratios when the respective test samples were annealed.

“∇” indicates a sample according to a comparison (“comparison sample”) in which CoFeB alloy is used as the first magnetization free layer and in which the second magnetization free layer is blank.

“⋄” indicates a comparison sample in which CoFeNiB alloy is used as the first magnetization free layer and in which the second magnetization free layer is blank.

“□” indicates a comparison sample in which Co₇₀Fe₃₀ is used as the first magnetization free layer and in which Ni₈₃Fe₁₇ is used as the second magnetization free layer.

“Δ” indicates a sample according to the first example in which (Co₇₀Fe₃₀)₈₀B₂₀ is used as the first magnetization free layer and in which Ni₈₃Fe₁₇ is used as the second magnetization free layer.

“◯” indicates a sample according to the first example in which (Co₇₀Fe₃₀)₉₆B₄ is used as the first magnetization free layer and in which Ni₈₃Fe₁₇ is used as the second magnetization free layer.

As obvious from FIG. 6, the samples according to the present invention has high MR ratios and exhibit notable effects of heat stability, that is, non-dependence of the MR ratios on the temperature, as compared with the comparisons.

Further, in Example 1, Hₑₓ* is 1,000 Oe and H_{cf} is 50 Oe and the relation of Hₑₓ*>H_{cf} is satisfied.

In Example 1, a method of measuring the MR ratio and a method of measuring the Hₑₓ* and H_{cf} are as follows.

MR ratio: Measured by Current-In-Plane Tunneling (CIPT) method using a 12-probe probe. Measurement principle of the CIPT method is described in D. C. Worledge, P. L. Trouilloud, “Applied Physics Letters”, 83 (2003), 84-86.

Hₑₓ* and H_{cf}: Measured from magnetization curves obtained using a vibrating sample magnetometer (VSM). Measurement principle of the VSM is described in, for example, Keiichiro Kon and Hiroshi Yasuoka Edited, Jikken Kagaku Koza [Experimental Physics Course] 6, Magnetic Measurement I, Maruzen Company, Limited, Issued Feb. 15, 2000.

### Example 2

The bottomed spin-valve tunnel magnetoresistive thin film having the film configuration shown in FIG. 1(b) was manufactured. In Example 2, samples were similar to those in Example 1 except that an Ru film (2 nm) was layered as the exchange-coupling nonmagnetic layer 9 on the magnetization free layer including the CoNiFeB/NiFe films similar to each sample in Example 1 according to the present invention, and that a NiFe film (3 nm) was then layered as the magnetization free layer 7c on the exchange-coupling nonmagnetic layer 9.

Each of obtained magnetoresistive thin films exhibited improved heat resistance as well as a high MR ratio and low magnetostriction similarly to Example 1.

### Example 3

The bottomed spin-valve tunnel magnetoresistive thin films using the samples according to the present invention similarly to Example 1 except that the magnetization fixed layer 4 was amorphous CoFeB (3 nm) were manufactured.

Each of obtained magnetoresistive thin films exhibited improved heat resistance as well as a high MR ratio and low magnetostriction similarly to Example 1.

1. A tunnel magnetoresistive thin film comprising:
a magnetization fixed layer;
a tunnel barrier layer; and
a magnetization free layer,
wherein the tunnel barrier layer is a magnesium oxide film containing magnesium oxide crystal grains in (001) orientation, and
the magnetization free layer is a layered structure including a first magnetization free layer and a second magnetization free layer, the first magnetization free layer being made of alloy containing Co atoms, Fe atoms, and B atoms or containing Co atoms, Ni atoms, Fe atoms, and B atoms, having a body-centered cubic structure, and having (001) orientation, the second magnetization free layer being made of alloy containing Fe atoms and Ni atoms and having a face-centered cubic structure.

2. The tunnel magnetoresistive thin film according to claim 1,
wherein the first magnetization free layer has a composition expressed as (Co_{100-x-y}NiₓFe_{y})_{100-z}B_{z}, where x, y, and z in atomic %, the composition satisfying x+y<100, 0≦x≦30, 10≦y<100, and 0<z<6.

3. The tunnel magnetoresistive thin film according to claim 1,
wherein a coercive force H_{cp} of the magnetization fixed layer and a coercive force H_{cf} of the magnetization free layer satisfy a relation of H_{cp}>H_{cf}.

4. The tunnel magnetoresistive thin film according to claim 1,
further comprising an antiferromagnetic layer adjacent to the magnetization fixed layer,
wherein magnetization of the magnetization fixed layer is fixed in a uniaxial direction by exchange-coupling between the magnetization fixed layer and the antiferromagnetic layer, and
an exchange-coupled magnetic field Hₑₓ between the magnetization fixed layer and the antiferromagnetic layer and a coercive force H_{cf} of the magnetization free layer satisfy a relation of Hₑₓ<H_{cf} Hₑₓ>H_{cf}.

5. The tunnel magnetoresistive thin film according to claim 1,
wherein the magnetization fixed layer includes a first magnetization fixed layer and a second magnetization fixed layer, and further includes an exchange-coupling nonmagnetic layer between the first magnetization fixed layer and the second magnetization fixed layer,
magnetization of the magnetization fixed layer is fixed in a uniaxial direction by exchange-coupling between the magnetization fixed layer and the antiferromagnetic layer,
the first magnetization fixed layer and the second magnetization fixed layer constitute an antiferromagnetically-coupled layered ferrimagnetic fixed layer, and
an antiferromagnetically-coupled magnetic field Hₑₓ* between the first magnetization fixed layer and the second magnetization fixed layer and a coercive force H_{cf} of the magnetization free layer satisfy a relation of Hₑₓ*>H_{cf}.

6. A tunnel magnetoresistive thin film comprising:
a magnetization free layer;
a tunnel barrier layer; and
a magnetization fixed layer,
wherein the tunnel barrier layer is a magnesium oxide film containing magnesium crystal grains in (001) orientation, and
the magnetization free layer is an alloy layer having a body-centered cubic structure, having (001) orientation, and containing Co atoms, Fe atoms, and B atoms or containing Co atoms, Ni atoms, Fe atoms, and B atoms.

7. The tunnel magnetoresistive thin film according to claim 6,
wherein the magnetization free layer has a composition expressed as (Co_{100-x-y}NiₓFe_{y})_{100-z}B_{z}, where x, y, and z in atomic %, the composition satisfying x+y<100, 0≦x≦30, 10≦y<100, and 0<z≦6.

8. A tunnel magnetoresistive thin film comprising a layered body having a magnetization fixed layer, a tunnel barrier layer, and a magnetization free layer layered in this order,
wherein the tunnel barrier layer is a magnesium oxide film containing magnesium crystal grains in (001) orientation, and
the magnetization free layer is a layered structure including a first magnetization free layer and a second magnetization free layer, the first magnetization free layer being made of alloy containing Co atoms, Fe atoms, and B atoms or containing Co atoms, Ni atoms, Fe atoms, and B atoms having a body-centered cubic structure, and having (001) orientation, the second magnetization free layer being made of alloy containing Fe atoms and Ni atoms and having a face-centered cubic structure.

9. A magnetic multilayer film formation apparatus comprising:
a transport chamber including a substrate transport device;
a first film formation chamber, arranged to be connected to the transport chamber via a gate valve, for forming a magnesium oxide layer containing magnesium oxide crystal grains in (001) orientation by a sputtering method using a magnesium oxide target;
a second film formation chamber, arranged to be connected to the transport chamber via a gate valve, for forming a crystalline first magnetization free layer made of alloy containing Co atoms, Fe atoms, and B atoms or alloy containing Co atoms, Ni atoms, Fe atoms, and B atoms, having a body-centered cubic structure, and having (001) orientation by the sputtering method using a magnetic target containing Co atoms, Fe atoms, and B atoms or a magnetic target containing Co atoms, Ni atoms, Fe atoms, and B atoms, and for forming a second magnetization free layer made of FeNi alloy containing Fe atoms and Ni atoms and having a face-centered cubic structure by the sputtering method using a magnetic target containing Fe atoms and Ni atoms; and
a vacuum transport mechanism for layering the first magnetization free layer on a substrate so as to be adjacent to the magnesium oxide layer, and for layering the second magnetization free layer so as to be adjacent to the first magnetization free layer.

10. A magnetic multilayer film formation apparatus comprising:
a transport chamber including a substrate transport device;
a first film formation chamber, arranged to be connected to the transport chamber via a gate valve, for forming a magnesium oxide layer containing magnesium oxide crystal grains in (001) orientation by a sputtering method using a magnesium oxide target;
a second film formation chamber, arranged to be connected to the transport chamber via a gate valve, for forming a crystalline first magnetization free layer made of alloy containing Co atoms, Fe atoms, and B atoms or alloy containing Co atoms, Ni atoms, Fe atoms, and B atoms, having a body-centered cubic structure, and having (001) orientation by a double simultaneous sputtering method using a first magnetic target containing at least two components selected from among Co atoms, Ni atoms, Fe atoms, and B atoms and a second magnetic target containing at least components selected from among the four components and unused in the first magnetic target, and for forming a second magnetization free layer made of FeNi alloy containing Fe atoms and Ni atoms and having a face-centered cubic structure by the sputtering method using a magnetic target containing Fe atoms and Ni atoms; and
a vacuum transport mechanism for layering the first magnetization free layer on a substrate so as to be adjacent to the magnesium oxide layer, and for layering the second magnetization free layer so as to be adjacent to the first magnetization free layer.

11. A magnetic multilayer film formation apparatus comprising:
a transport chamber including a substrate transport device;
a first film formation chamber, arranged to be connected to the transport chamber via a gate valve, for forming a metal magnesium layer by a sputtering method using a magnesium target;
an oxidation treatment chamber, arranged to be connected to the transport chamber via a gate valve, for transforming the magnesium layer into a magnesium oxide layer containing magnesium oxide crystal grains in (001) orientation;
a second film formation chamber, arranged to be connected to the transport chamber via a gate valve, for forming a crystalline first magnetization free layer made of alloy containing Co atoms, Fe atoms, and B atoms or alloy containing Co atoms, Ni atoms, Fe atoms, and B atoms, having a body-centered cubic structure, and having (001) orientation by a double simultaneous sputtering method using a first magnetic target containing at least two components selected from among Co atoms, Ni atoms, Fe atoms, and B atoms and a second magnetic target containing at least components selected from among the four components and unused in the first magnetic target, and for forming a second magnetization free layer made of FeNi alloy containing Fe atoms and Ni atoms and having a face-centered cubic structure by the sputtering method using a magnetic target containing Fe atoms and Ni atoms; and
a vacuum transport mechanism for layering the first magnetization free layer on a substrate so as to be adjacent to the magnesium oxide layer, and for layering the second magnetization free layer so as to be adjacent to the first magnetization free layer.

12. A magnetic multilayer film formation apparatus comprising:
a transport chamber including a substrate transport device;
a first film formation chamber, arranged to be connected to the transport chamber via a gate valve, for forming a metal magnesium layer by a sputtering method using a magnesium target;
an oxidation treatment chamber, arranged to be connected to the transport chamber via a gate valve, for transforming the magnesium layer into a magnesium oxide layer containing magnesium oxide crystal grains in (001) orientation;
a second film formation chamber, arranged to be connected to the transport chamber via a gate valve, for forming a crystalline first magnetization free layer made of alloy containing Co atoms, Fe atoms, and B atoms, or alloy containing Co atoms, Ni atoms, Fe atoms, and B atoms, having a body-centered cubic structure, and having (001) orientation by the sputtering method using a magnetic target containing Co atoms, Fe atoms, and B atoms or a magnetic target containing Co atoms, Ni atoms, Fe atoms, and B atoms and for forming a second magnetization free layer made of FeNi alloy containing Fe atoms and Ni atoms and having a face-centered cubic structure by the sputtering method using a magnetic target containing Fe atoms and Ni atoms; and
a vacuum transport mechanism for layering the first magnetization free layer on a substrate so as to be adjacent to the magnesium oxide layer, and for layering the second magnetization free layer so as to be adjacent to the first magnetization free layer.
